(19) United States
(12) Patent Application Publication
(10) Pub. No.: US 2022/0057215 A1
(43) Pub. Date: Feb. 24, 2022

(54) RAPID LOCATION-BASED ASSOCIATION OF CARRIERS AND ITEMS

(71) Applicant: ZEBRA TECHNOLOGIES CORPORATION, Lincolnshire, IL (US)

(72) Inventors: Varsha Ananth, Buffalo Grove, IL (US); Michael P. Cote, Princeton, MA (US); Robert K. Ekl, Arlington Heights, IL (US); Scott R. Olson, St. Paul, MN (US)

(21) Appl. No.: 16/996,244

(22) Filed: Aug. 18, 2020

(51) Int. Cl. G01C 21/20; G01C 21/00

(52) U.S. Cl. CPC G01C 21/206; G01C 21/383

(57) ABSTRACT

A method includes: obtaining, at a computing device, respective location data corresponding to a carrier and each of a set of items; for each item in the set of items: storing a previous association state between the item and the carrier; generating a set of attributes defining a spatial relationship between the item and the carrier; providing the set of attributes to a classifier to detect a current association state between the carrier and the item; and responsive to determining that the current association state between the carrier and the item is different from the previous association state, transmitting a status update message to a dispatcher configured to provide directional guidance to the carrier.

### BACKGROUND

Facilities such as warehouses may contain various items (e.g. pallets or the like), as well as vehicles such as forklifts employed transport the items. A dispatching system may provide directional guidance to a vehicle operator based on which item is currently carried by the vehicle. The directional guidance may indicate where within the facility to deliver the item. To detect which items are carried by which vehicles, detected locations for items and vehicles can be examined to detect correlated motion between items and vehicles. However, detecting correlated motion may be time-consuming, leaving vehicles idle or travelling to incorrect locations in the absence of directional guidance.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for location-based association of carriers and items.

FIG. 2 is a block diagram of certain components of the server of FIG. 1.

FIG. 3 is a flowchart of a location-based association of carriers and items.

FIG. 4A is a diagram illustrating an example performance of block 305 of the method of FIG. 3.

FIG. 4B is a diagram illustrating an example performance of block 315 of the method of FIG. 3.

FIGS. 5A, 5B, and 5C illustrate further example location data obtained at successive performances of block 305 of the method of FIG. 3.

FIG. 6A is a diagram illustrating a sequence of attributes generated through successive performances of block 320 of the method of FIG. 3.

FIG. 6B is a diagram illustrating interpolation of additional attributes from the attributes of FIG. 6A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: obtaining, at a computing device, respective location data corresponding to a carrier and each of a set of items; for each item in the set of items: storing a previous association state between the item and the carrier; generating a set of attributes defining a spatial relationship between the item and the carrier; providing the set of attributes to a classifier to detect a current association state between the carrier and the item; and responsive to determining that the current association state between the carrier and the item is different from the previous association state, transmitting a status update message to a dispatcher configured to provide directional guidance to the carrier.

Other examples disclosed herein are directed to a computing device, comprising: a memory; a communications interface; and a processor configured to: obtain, via the communications interface, respective location data corresponding to a carrier and each of a set of items; for each item in the set of items: store a previous association state between the item and the carrier; generate a set of attributes defining a spatial relationship between the item and the carrier; provide the set of attributes to a classifier to detect a current association state between the carrier and the item; and responsive to determining that the current association state between the carrier and the item is different from the previous association state, transmit a status update message to a dispatcher configured to provide directional guidance to the carrier.

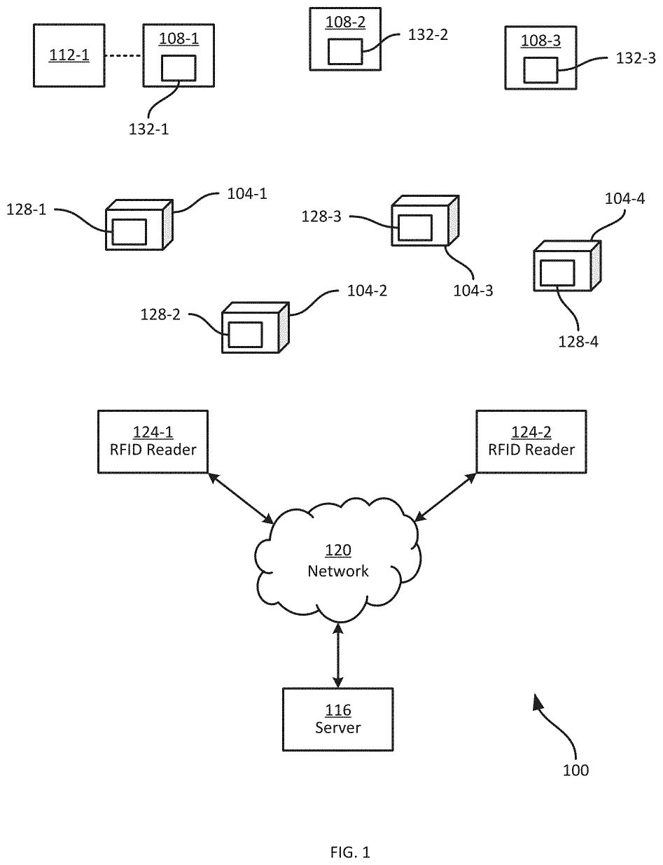

FIG. 1 shows a system 100 for location-based association of carriers and items. The system 100 can be deployed, for example, in a facility such as a warehouse, although it will be apparent to those skilled in the art that the system 100 may also be deployed in various other facilities in which items are transported, such as manufacturing facilities.

The system 100 includes a plurality of items 104, four examples 104-1, 104-2, 104-3, and 104-4 of which are shown in FIG. 1. The items can be pallets, packages, or the like. The system 100 also includes a plurality of carriers 108, which can include vehicles such as forklifts. Three example carriers 108-1, 108-2, and 108-3 are shown in FIG. 1. As will be apparent, the system 100 may include a wide range of numbers of items and carriers greater and smaller than the numbers shown for illustrative purposes in FIG. 1.

Each carrier 108 can be associated with a mobile computing device 112. Thus, the carrier 108-1 is shown with an associated mobile computing device 112-1. In some examples, the device 112-1 is mounted on the carrier 108-1 (e.g. a forklift). In other examples, the device 112-1 is a wearable computing device, such as a wrist-mounted computer or the like, worn by a human operator of the carrier 108-1. In still other examples, the carrier 108-1 is an autonomous or semi-autonomous vehicle, and the computing device 112-1 can therefore be integrated with the carrier 108-1. In some implementations, the carrier 108 may simply be a human worker within the facility, and the device 112-1 may be a wearable computing device as mentioned above.

The carriers 108 are controlled, e.g. by human operators or autonomously, to retrieve, transport, and deposit items 104 within the facility. For example, items 104 may arrive in a first region of the facility, and be transported to one or more other regions of the facility for consumption in a production or packaging process, for shipping to other facilities, or the like. The destination region to which a given item 104 is to be transported can depend on the nature of the item. The carriers 108, however, may be controlled to retrieve items of various different types, for example because several types of items are available for transport from a single region of the facility.

The system 100 therefore also includes a dispatcher to provide directional guidance to the carriers 108. In particular, the system 100 includes a server 116 connected with the carrier-associated computing devices 112 via a network 120 (e.g. a suitable combination of local and wide-area networks). The server 116 can implement dispatching functionality by which the server 116 obtains an association between a carrier 108 and an item 104 (i.e. an indication that the carrier 108 is currently carrying the item 104), and transmits directional guidance to the carrier 108 based on an identifier of the item. For example, the server 116 may maintain data indicating target locations within the facility for each item 104, and may therefore retrieve a target location based on the above association, and provide the target location to the mobile computing device 112 associated with the carrier 108.

The server 116 may also provide directional guidance to a carrier 108 (e.g. via the associated device 112) when an association between the carrier 108 and an item 104 is terminated. That is, when a carrier deposits an item 104 at the target location, and therefore becomes unassociated with any item 104, the server 116 may detect such a lack of association and provide directional guidance to the carrier 108 to travel to a region of the facility containing further items for transport.

To detect associations between items 104 and carriers 108, the server 116 receives location data indicating the positions and orientations of the items 104 and carriers 108 within the facility (and, in some examples, the velocity of the items 104 and carriers 108). For example, the system 100 can include at least one radio frequency identification (RFID) reader 124, of which two examples 124-1 and 124-2 are shown in FIG. 1. The readers 124, as will be apparent to those skilled in the art, are configured to repeatedly scan corresponding areas of the facility for RFID tags, and to compute location data for such tags.

The items 104 and carriers 108 each include an RFID tag. Thus, in the illustrated example, the items 104 include respective tags 128-1, 128-2, 128-3, and 128-4, and the carrier 108-1 includes a tag 132-1. The remaining carriers 108 also include corresponding tags 132-2, and 132-3. Each tag encodes an identifier of the corresponding item 104 or carrier 108. The readers 124 can therefore detect locations (e.g. including velocities in some implementations) of the items 104 and carriers 108, and report such location data to the server 116 for use in the dispatching functionality mentioned above.

The server 116 also implements association tracking functionality, by which the server 116 performs the above-mentioned detection of associations between items 104 and carriers 108. Some systems detect such associations by comparing the motion of an item 104 and a carrier 108 over time to detect whether the motion is sufficiently correlated to indicate that the item 104 is being carried by the carrier 108. For example, sufficiently correlated motion may include movement in directions that differ by less than a threshold, for at least a threshold period of time. However, due to measurement errors in RFID locationing, arriving at a robust correlation between the motion of an item 104 and the motion of a carrier 108 may be time-consuming (e.g. between five and ten seconds). During the time before the correlation is confirmed and directional guidance can be provided, the carrier 108 may be stationary, or may travel in an incorrect direction.

The server 116 implements association detection mechanisms that may enable associations between items 104 and carriers 108 to be detected more rapidly than the motion correlation mentioned above. As will be discussed below, the server 116 generates a variety of attributes from location data received from the readers 124, and applies classification mechanisms to those attributes to detect associations between items 104 and carriers 108.

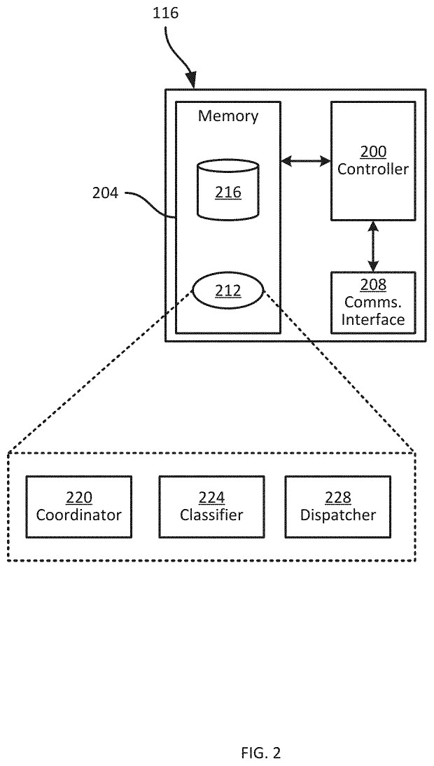

Turning to FIG. 2, certain components of the server 116 are illustrated. The server 116 includes a controller 200 such as a central processing unit (CPU) connected with a non-transitory computer readable storage medium, such as a memory 204. The memory 204 includes any suitable combination of volatile memory (e.g. Random Access Memory (“RAM”)) and non-volatile memory (e.g. read only memory (“ROM”), Electrically Erasable Programmable Read Only Memory (“EEPROM”), flash memory). In general, the controller 200 and the memory 204 each comprise one or more integrated circuits.

The server 116 also includes a communications interface 208 enabling the server 116 to communicate with other computing devices, e.g. via the network 120. For example, the communications interface 208 enables the server 116 to receive location data from the readers 124, and to provide directional guidance to the carriers 108, via the associated computing devices 112. The communications interface 208 includes any suitable combination of hardware elements (e.g. network interface controllers and the like) and corresponding firmware and/or software for controlling such components.

Although the server 116 is illustrated as a discrete computing device, containing the above-mentioned components in a single physical enclosure, in other embodiments, the server 116 is implemented as a distributed computing device in which the above-mentioned components are implemented on a plurality of underlying hardware devices (e.g. a plurality of controllers 200 and associated memories 204). The server 116 can be deployed at the facility in which the carriers 108 operator, but may also be deployed remotely from the facility in some examples.

The memory 204 stores a plurality of instructions for execution by the controller 200 to implement functionality related to the sequence tracking and output generation mentioned above. In particular, the memory 204 stores a directional guidance application 212 (also referred to simply as the application 212), whose execution by the controller 200 configures the controller 200 to obtain location data for the items 104 and carriers 108, detect changes in associations between items 104 and carriers 108, and provide directional guidance to the carriers 108 based on such association changes.

The memory 204 also stores a repository 216 containing data employed by the application 212, such as detected associations between items 104 and carriers 108, as well as item and carrier identifiers (e.g. those encoded in the tags 128 and 132) and target locations for the items 104.

Certain modules of the application 212 are also illustrated in FIG. 2. In some examples, the illustrated modules may be implemented as discrete applications on the server 116 or across multiple servers. Further, in some examples any or all of the illustrated modules may be implemented via specialized hardware elements (e.g. application-specific integrated circuits (ASICs) or the like).

The application 212 includes a coordinator 220, configured to obtain location data from the readers 124 and generate the above-mentioned attributes from the location data. The coordinator 220 provides the attributes to a classifier 224. The classifier 224 is configured to implement any of a variety of classification mechanisms, such as a neural network (e.g. a Long-Short-Term Memory Recurrent Neural Network, or LTSM RNN) to determine, from the attributes, whether various pairs of items 104 and carriers 108 are associated. The coordinator 220, upon receiving association detections from the classifier 224, maintains current association states between items 104 and carriers 108 (e.g. in the repository 216), and provides indications of changes in association to a dispatcher 228.

The dispatcher 228 is configured, in response to receiving changes in association between items 104 and carriers 108 from the coordinator 220, to generate and provide directional guidance to carriers 108, e.g. by transmitting target locations to the corresponding mobile computing devices 112. The target locations can indicate, for example, where to drop off a currently associated item, where to travel to pick up another item, or the like.

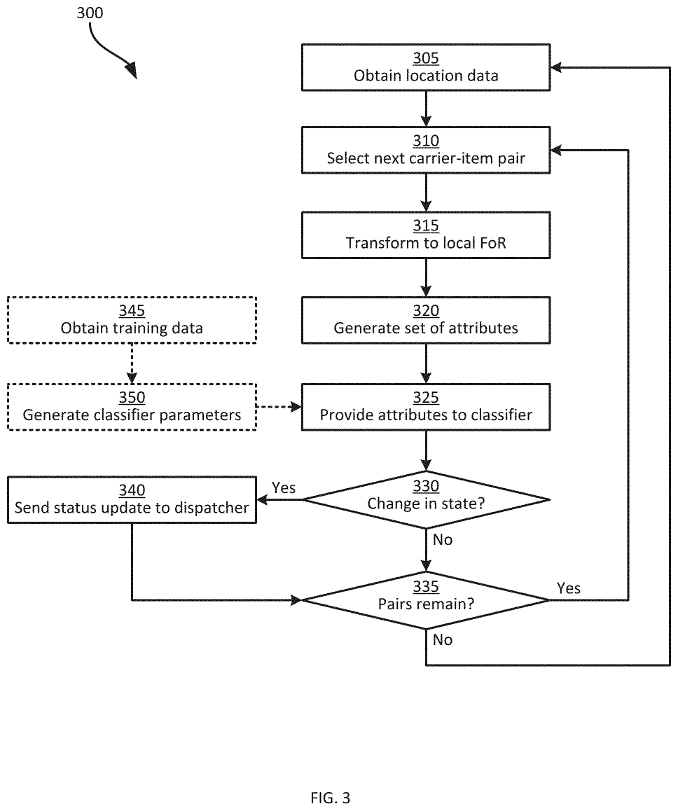

Turning to FIG. 3, the operation of the system 100 will be discussed in greater detail. In particular, FIG. 3 illustrates a method 300 of location-based association between items 104 and carriers 108, which will be discussed in conjunction with its performance by the server 116 via execution of the application 212.

At block 305, the server 116, and specifically the coordinator 220, is configured to obtain location data for each of the items 104 and the carriers 108. For example, the server 116 can obtain the location data by receiving the location data from the readers 124. The readers 124 are configured (either independently or upon instruction from the server 116) to periodically scan the facility for any detectable tags, and to determine the location data. The frequency with which the readers 124 scan may be, for example, twice per second, although a wide variety of other frequencies are also contemplate, including faster and slower scan frequencies.

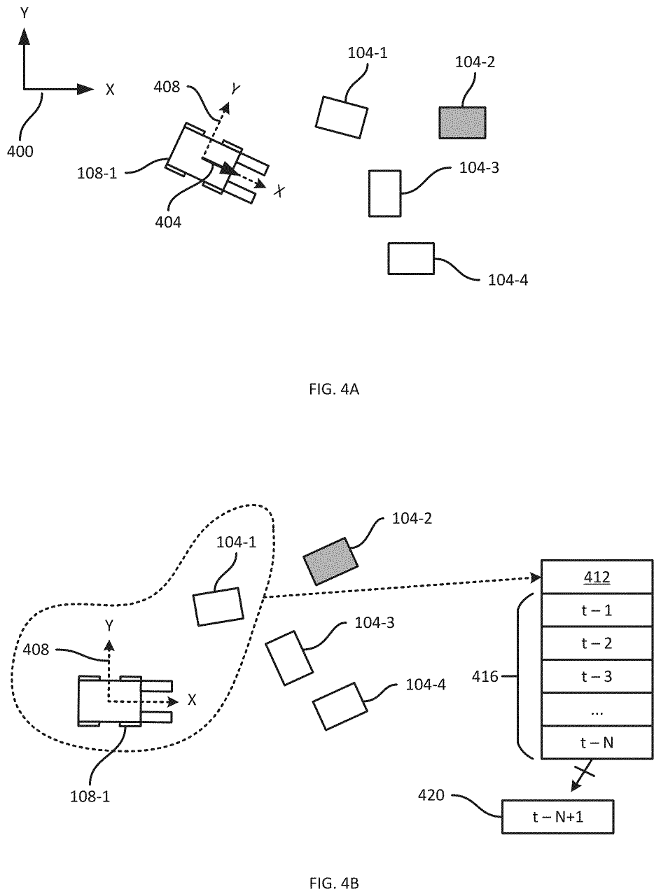

The location data includes a location of each entity (i.e. an item 104 or a carrier 108) within the facility, according to a predefined frame of reference. The location data can also include an orientation and a speed of movement (e.g. a velocity vector) for each entity. Turning to FIG. 4A, the carrier 108-1 and the items 104 are shown in an example layout within the facility. The location data received at block 305 can include a location of each item 104, such as coordinates of a center of the item 104 in a frame of reference 400. The location data can also include a location of the carrier 108-1, such as coordinates of a center of the carrier 108 in the frame of reference 400. The frame of reference 400 is predefined in the facility, e.g. when the system 100 is deployed.

The location data can also include velocities for each of the items 104 and the carrier 108. The items 104 as shown in FIG. 4A are assumed to be stationary, and therefore have velocities of zero. The velocity 404 (i.e. orientation and speed) of the carrier 108-1 is shown by a solid arrow.

Returning to FIG. 3, at block 310, the server 116 is configured to select the next vehicle-item pair. That is, the server 116 is configured to perform various actions corresponding to a given pairing of the carrier 108-1 with a given item 104. Those actions may be repeated for a plurality of carrier-item pairs. Although the example shown in FIG. 4A includes only one carrier 108, it will be apparent in the discussion herein that these actions may also be repeated for pairings between other carriers 108 and the items 104, when multiple carriers 108 are present.

The server 116 can select a carrier-item pair, for example, by selecting a carrier 108 (in the present example, only the carrier 108-1 is available for selection), and by then selecting a subset of the items 104 that are within a threshold distance of the location of the carrier 108. Each item within the subset is then processed as a pair with the carrier 108. Thus, if four items 104 are within the threshold distance of the carrier 108, four pairs will be processed as described below. Subsequent pairs are identified for processing by selecting the next carrier 108, and selecting a further subset of items 104 based on the threshold distance.

In the present example, referring again to FIG. 4A, it is assumed that the items 104-1, 104-3, and 104-4 are within the above-mentioned threshold distance of the carrier 108. The location data of the item 104-2, in other words, will not be processed in the current performance of the method 300 (and the item 104-2 is therefore shown as shaded). At block 310, the server 116 is therefore configured to select a pairing of the carrier 108-1 with one of the items 104-1, 104-3, and 104-4.

At block 315, the server 116 is configured to transform the location data of the selected pair to a local frame of reference. The local frame of reference has an origin at the location of the carrier 108 of the pair (i.e. the carrier 108-1, in this example), and one of the axes of the local frame of reference is co-axial with the orientation of the carrier 108.

Turning to FIG. 4B, a local frame of reference 408 is shown as centered on and aligned with the carrier 108-1. The local frame of reference 408 is also shown in FIG. 4A to illustrate the difference in origin placement and axis orientation relative to the facility frame of reference 400. At block 315, therefore, the locations of the items 104 within the above-mentioned subset are redefined relative to the location and orientation of the carrier 108-1.

At block 320, the server 116 is configured to generate a set of attributes defining a spatial relationship between the item 104 and the carrier 108 that define the pair selected at block 310. For example, the pair defined by the carrier 108-1 and the item 104-1 will be discussed first. At block 320, the server 116 is therefore configured to generate a set of attributes that define a spatial relationship between the carrier 108-1 and the item 104-1.

A wide variety of attributes are contemplated for generation at block 320. For example, the attributes can include the location of the carrier 108-1 in the frame of reference 400, and/or the velocity 404 of the carrier 108-1 in the frame of reference 400. The velocity can be expressed as two attributes in some examples, namely a speed and a heading or orientation. The attributes can also include a velocity of the item 104-1 in the local frame of reference 408. The attributes can further include a location of the item 104-1 in the local frame of reference 408. That is, the velocity and location attributes for the item 104-1 are defined in relation to the carrier 108-1, rather than according to the frame of reference 400. As will be apparent, the location and velocity attributes for a given item 104 therefore differ depending on which item-carrier pair the attributes are being computed for. Thus, the attributes define the spatial relationship between a specific pairing of a carrier 108 and an item 104.

The attributes generated at block 320 represent the spatial relationship between the item 104-1 and the carrier 108-1 for the current sampling of location data from block 305. That is, the attributes from block 320 represent the spatial relationship between the item 104-1 and the carrier 108-1 at a specific point in time. The attributes from block 320 can be appended to a time series that contains a plurality of additional attribute sets arising from previous performances of block 320 (based on previous location data). The time series, in other words, represents the changing spatial relationship between the item 104-1 and the carrier 108-1 over time

Referring to FIG. 4B, a set of attributes 412 is illustrated as the output to block 320. The set of attributes 412 are stored with a time series 416 of attribute sets that includes a plurality of previous attribute sets, from previous location data samples (indicated by their position in time, e.g. t−1 being one location data sample before the current performance of the method 300, t−2 being two location samples before current, and so on). The time series may have a predetermined maximum length, e.g. corresponding to a time t−N. For example the time series may cover a total of fifteen seconds in some implementations, with a sampling interval of 0.5 seconds. Thus, the time series 416, with the current attributes 412, may contain 30 sets of attributes. When the attributes 412 are added to the time series 416, an oldest attribute set 420 (corresponding to a time t−N+1) may be discarded.

The attribute sets in the series 416 can also include a further attribute that is not directly derived from the location data obtained at block 305. In particular, the previous attribute sets can include respective previous association states between the item 104-1 and the carrier 108-1. The association states arise from previous performances of the remainder of the method 300. The attribute set 412 itself may not include an association state, as the current association state is determined by the classifier 224 using the attribute set 412 and the remainder of the series 416, as described below.

In some examples, multiple performances of blocks 315 and 320 may be batched. For example, as noted above the server 116 can identify a subset of items 104 within a threshold distance of a given carrier 108. Each item 104 in the subset may be transformed to the local frame of reference 408 substantially simultaneously, e.g. before proceeding to block 320 for any of the items 104.

At block 325, the server 116 is configured to provide the attributes generated at block 320 for classification. For example, the coordinator 220 can provide the attributes 412 and 416 to the classifier 224. The attributes may be provided to the classifier, for example, as a two-dimensional matrix, with each row containing a given subset of attributes (i.e. from one performance of block 320), and columns corresponding to respective types of attributes from multiple subsets.

The classifier 224, such as the above-mentioned neural network, is configured to receive the above-mentioned input (e.g. a two-dimensional matrix containing a time series of attribute sets representing multiple performances of block 320 for the relevant carrier-item pair), and to generate output indicating whether the pair is associated or not associated. That is, the classifier 224 is configured to infer, from the attribute set(s), an association state between the carrier 108 (e.g. the carrier 108-1 in the present example) and the item 104 (e.g. the item 104-1 in the present example).

As will be apparent to those skilled in the art, the classifier 224 may detect associations or dissociations between items 104 and carriers 108 based on the attributes from successive performances of block 320. The classifier 224, prior to deployment, is trained, e.g. using training data collected within the facility and labelled with ground truth association states. The collection and use of training data will be discussed in further below.

The output generated by the classifier 224 can include an association state indicator, and a confidence level associated therewith. The association state indicator is an indication of whether the item 104-1 is physically coupled with the carrier 108-1 (i.e. being carried by the carrier 108-1). The association state indicator can be a binary value, e.g. ‘1’ for associated, indicating that the item 104-1 is being carried by the carrier 108-1, and ‘0’ for disassociated, indicating that the item 104-1 is not being carrier by the carrier 108-1. Various other forms of association state indicator are also contemplated. The confidence level indicates, e.g. as a percentage or other score, a degree of confidence that the association state indicator is correct. The coordinator 220 can be configured to discard classifier output with a confidence level below a predetermined threshold (e.g. 80%, although higher or lower thresholds may be employed in other examples).

Having obtained a current state association indicator for the relevant item-carrier pair at block 325, and assuming that the confidence level associated with the indicator exceeds the threshold mentioned above, the server 116 is configured to proceed to block 330. At block 330, the server 116 is configured to determine whether the state indicator obtained at block 325 represents a change in the association state for the relevant carrier-item pair. That is, the server 116 is configured to retrieve a previous association state indicator for the pair from the repository 216 (resulting from the previous performance of block 325 for the same pair). If the current association state indicator is the same as the current indicator, the determination at block 330 is negative.

Following a negative determination at block 330, the server 116 proceeds to block 335, to determine whether further item-carrier pairs remain to be processed. When the determination at block 335 is affirmative, the server 116 returns to block 310 to select the next pair for processing. When the determination at block 335 is negative, the server 116 instead returns to block 305 to obtain further location data. When, as mentioned above, the confidence level from block 325 is below the threshold, the determination at block 330 is automatically negative, and the server 116 proceeds to block 335.

If the current association state is different from the previous association state, the determination at block 330 is affirmative and the server 116 proceeds instead to block 340. A change in association state between the previous and current association states for a given item-carrier pair indicates that the item 104 was previously being carried by the carrier 108 and has been dropped off, or that the item 104 was previously not being carried by the carrier 108 and now is being carried.

At block 340, the server 116 is configured to update the repository 216 with the current association state indicator, and to send a status update message, e.g. to the dispatcher 228. The status update message contains an identifier of the carrier 108 and the item 104 of the relevant pair (the carrier 108-1 and the item 104-1 in the present example). The identifiers can be obtained at block 305, along with the location data, from the tags affixed to the items 104 and carrier 108. The status update message also contains the association state indicator from block 325. As will be apparent to those skilled in the art, the dispatcher 228 can be configured, in response to receiving the status update message, to generate and provide directional guidance to the carrier 108 of the relevant pair.

The directional guidance is generated, for example, based on the association state indicator. For example, when the association state indicator indicates that a carrier 108 is newly associated with an item 104, the dispatcher 228 can retrieve a target location for the item 104 (e.g. from the repository 216) and transmit information to the computing device 112 associated with the carrier 108 to guide the carrier 108 to the target location. When the association state indicator indicates that a carrier 108 is no longer associated with an item 104 with which the carrier 108 was previously associated (i.e. the carrier 108 has dropped the item 104 off), the directional guidance transmitted to the corresponding device 112 can include a target area of the facility that contains other items 104 for collection and transport.

After performing block 340, the server 116 proceeds to block 335, as described above. Thus, for each set of location data received at block 305, the server 116 can evaluate a plurality of item-carrier pairs to determine whether each pair is associated and trigger the generation of directional guidance when new associations or dissociations are detected.

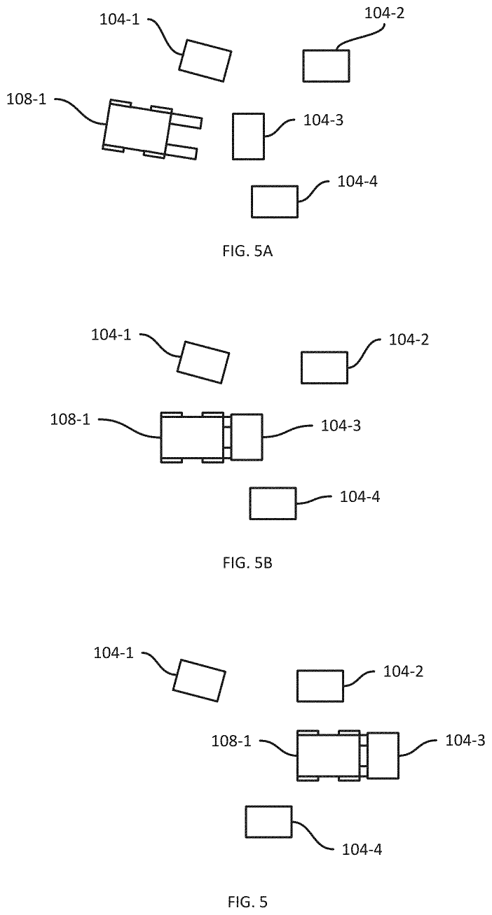

Referring to FIGS. 5A, 5B, and 5C, the items 104 and the carrier 108 are shown in three additional states following the state in FIG. 4A. That is, FIGS. 5A to 5C represent three subsequent points in time after the state shown in FIG. 4A, in which the carrier 108-1 approaches (FIG. 5A), picks up (FIG. 5B), and begins transporting (FIG. 5C) the item 104-3. The server 116, via repeated performances of the method 300, generates association state indicators (via block 325) for each of the items 104. Although the item 104-2 was excluded from the subset of items 104 to be processed in the example of FIG. 4A, the movement of the carrier 108-1 brings the carrier 108 sufficiently close to the item 104-2 that it is assumed that the item 104-2 is also processed. That is, four item-carrier pairs are processed for each of the scenarios shown in FIGS. 5A to 5C.

The server 116 is configured to detect, e.g. based on the location data corresponding to FIG. 5C, that the item 104-3 is newly associated with the carrier 108-1. In some examples, the server 116 may detect the association at the state shown in FIG. 5B rather than FIG. 5C. In any event, upon detection of the association, the server 116 provides directional guidance to operator of the carrier 108-1, e.g. by transmitting information to the computing device 112-1.

In some examples, the location data obtained at block 305 may not be obtained in precisely spaced intervals. For example, rather than location data being received at half-second intervals, some location data samples may be separated by more than, or less than, 0.5 seconds. The server 116 can therefore also be configured to preprocess the attributes generated at block 320, before providing the attributes to the classifier 224. Such preprocessing can include interpolating precisely-spaced attributes from those generated at block 320.

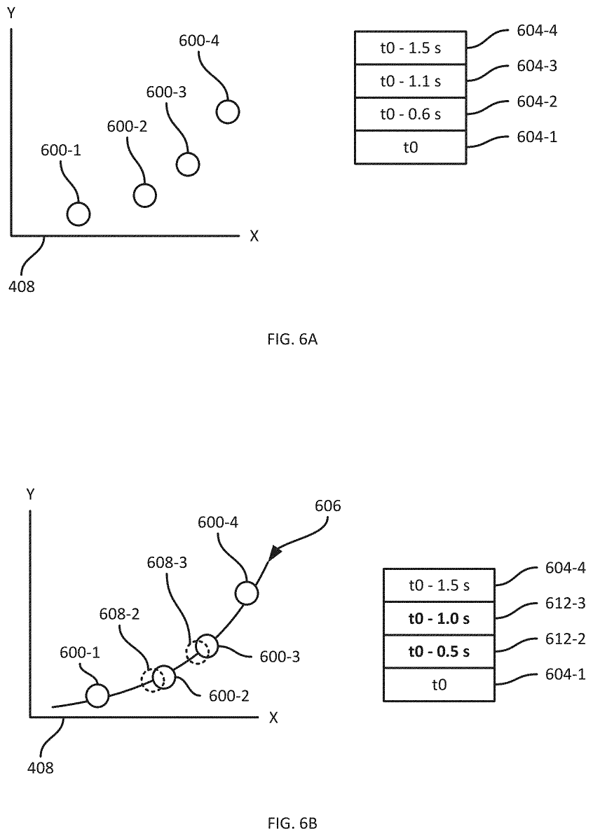

Turning to FIG. 6A, a series of location attributes 600-1, 600-2, 600-3, and 600-4 are shown according to the frame of reference 408. That is, the locations 600 represent the locations of an item 104 (e.g. the item 104-3) over time relative to the carrier 108-1. The location 600-1 is the most recently captured, while the location 600-4 is the oldest sample. The times 604-1, 604-2, 604-3, and 604-4 at which the locations 600 were captured are also indicated in FIG. 6A. For example, the location 600-2 was captured 0.6 seconds before the location 600-1.

To provide the classifier 224 with consistently formatted sets of attributes, the server 116 can be configured to generate attributes that conform to a predetermined sampling frequency (e.g. 0.5 seconds). For example, as shown in FIG. 6B, the server 116 can fit a curve or other guide feature 606 to the captured locations 600, and interpolate attributes 608-2 and 608-3 for use in place of attributes that did not fall on the predetermined sampling frequency. For example, the interpolated attributes 608-2 and 608-3 correspond to sampling times 612-2 and 612-3 that align with the predetermined 0.5 second sampling frequency. The above process can be repeated for each other attribute type in the set, before providing the time series of attribute sets to the classifier 224.

Returning to FIG. 3, as noted earlier the classifier 224 is configured to generate association state indicators and confidence levels based on classification parameters (e.g. parameters defining the behavior of nodes in a neural network). The classification parameters, in turn, are generated using a training process, e.g. when the system 100 is deployed. The training process may be repeated periodically, e.g. following physical changes to the facility layout or the like, after deployment.

In particular, at block 345, the server 116 is configured to obtain training data. The training data includes a plurality of location data samples (e.g. collected over a plurality of performances of block 305), labelled with ground truth association state indicators. The training data may be labelled manually. Training data may be collected during normal operations within the facility, or from a planned set of carrier 108 and item 104 trajectories through the facility.

In some examples, labelling the training data may be at least partially automated. For example, prior to the deployment of the system 100, the motion of items 104 and carriers 108 may be tracked as described above, and associations may be detected via correlated movement. Although such correlations may be slower than the process discussed herein, e.g. taking 5-10 seconds to identify associations and dissociations between items 104 and carriers 108, the detected association changes can be employed to generate labelled training data. For example, once an association change is detected via correlated motion, the attribute sets corresponding to the relevant item-carrier pair can be labelled with the detected association, including attribute sets preceding the detection in time by, for example, 5 seconds. At block 350, the server 116 is configured to generate and store the above-mentioned classification parameters.

As will now be apparent to those skilled in the art, the system 100 may enable detection of association state changes between items 104 and carriers 108 more rapidly and/or accurately than the detection of correlated motion alone. The use of various location-related attributes by the classifier 224 may enable the detection of association state changes based on patterns or trends that may be time-consuming or impossible to detect via manual analysis of location data. Further, the use of the classifier 224 may enable more rapid deployment of the system 100 in various facilities by mitigating or avoiding the need for such manual analysis.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
obtaining, at a computing device, respective location data corresponding to a carrier and each of a set of items;
for each item in the set of items:
storing a previous association state between the item and the carrier;
generating a set of attributes defining a spatial relationship between the item and the carrier;
providing the set of attributes to a classifier to detect a current association state between the carrier and the item; and
responsive to determining that the current association state between the carrier and the item is different from the previous association state, transmitting a status update message to a dispatcher configured to provide directional guidance to the carrier.

2. The method of claim 1, further comprising:
obtaining the location data for a plurality of items including the set of items; and
selecting the set of items from the plurality of items based on the location data.

3. The method of claim 2, further comprising:
selecting the set of items from the plurality of items based on respective distances between each of the plurality of items and the carrier.

4. The method of claim 1, further comprising:
updating a stored time series of attribute sets with the set of attributes; and
providing the time series to the classifier.

5. The method of claim 4, wherein the updating includes, when the stored time series has reached a threshold length, discarding an oldest one of the attribute sets.

6. The method of claim 1, wherein the set of attributes includes at least one of a location of the carrier, a velocity of the carrier, a location of the item, and a velocity of the item.

7. The method of claim 1, further comprising:
prior to generating the set of attributes, transforming the location data corresponding to the set of items to a local frame of reference based on a location of the carrier.

8. The method of claim 1, further comprising:
obtaining, from the classifier, a confidence level corresponding to the current association state;
when the confidence level is below a threshold, discarding the current association state.

9. The method of claim 1, wherein the previous association state and the current association state each indicate one of (i) an associated state indicating that the item is carried by the carrier, and (ii) a disassociated state indicating that the item is not carrier by the carrier.

10. The method of claim 1, wherein obtaining the location data includes receiving the location data from a set of tag readers.

11. A computing device, comprising:
a memory;
a communications interface; and
a processor configured to:
obtain, via the communications interface, respective location data corresponding to a carrier and each of a set of items;
for each item in the set of items:
store a previous association state between the item and the carrier;
generate a set of attributes defining a spatial relationship between the item and the carrier;
provide the set of attributes to a classifier to detect a current association state between the carrier and the item; and
responsive to determining that the current association state between the carrier and the item is different from the previous association state, transmit a status update message to a dispatcher configured to provide directional guidance to the carrier.

12. The computing device of claim 11, wherein the processor is further configured to:
obtain the location data for a plurality of items including the set of items; and
select the set of items from the plurality of items based on the location data.

13. The computing device of claim 12, wherein the processor is further configured to:
select the set of items from the plurality of items based on respective distances between each of the plurality of items and the carrier.

14. The computing device of claim 11, wherein the processor is further configured to:
update a stored time series of attribute sets with the set of attributes; and
provide the time series to the classifier.

15. The computing device of claim 14, wherein the processor is configured, in order to update the time series, to discard an oldest one of the attribute sets when the stored time series has reached a threshold length.

16. The computing device of claim 11, wherein the set of attributes includes at least one of a location of the carrier, a velocity of the carrier, a location of the item, and a velocity of the item.

17. The computing device of claim 11, wherein the processor is further configured to:
prior to generation of the set of attributes, transform the location data corresponding to the set of items to a local frame of reference based on a location of the carrier.

18. The computing device of claim 11, wherein the processor is further configured to:
obtain, from the classifier, a confidence level corresponding to the current association state;
when the confidence level is below a threshold, discard the current association state.

19. The computing device of claim 11, wherein the previous association state and the current association state each indicate one of (i) an associated state indicating that the item is carried by the carrier, and (ii) a disassociated state indicating that the item is not carrier by the carrier.

20. The computing device of claim 11, wherein the processor is configured, in order to obtain the location data, to receive the location data from a set of tag readers.
